(19) United States
(12) Patent Application Publication
(10) Pub. No.: US 2005/0046884 A1
(43) Pub. Date: Mar. 3, 2005

(54) Image processing apparatus, and image processing program storage medium

(75) Inventor: Yukihisa Ozaki, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/927,635

(22) Filed: Aug. 27, 2004

(30) Foreign Application Priority Data
Aug. 28, 2003 (JP) 2003-304851

(51) Int. Cl. H04N 1/387; H04N 1/56; H04N 1/62

(52) U.S. Cl. 358/1.9; 358/527; 358/531; 358/537

(57) ABSTRACT

In an image processing apparatus for performing “renewal designation” for designating a parameter group in accordance with a parameter group already designated, as well as usual “designation” in which an operator designates a desired parameter group, the parameter group, which is subjected to the renewal designation, is associated with the parameter group that is an original parameter group for the renewal designation. In the event a plural number of times of renewal designation is made in accordance with the same parameter group, a plurality of parameter groups is associated with one another on a parallel basis and is saved. Thus, the parameter groups, which are subjected to designation and renewal designation, are not erased and saved on a hierarchical basis. Accordingly, it is possible to restore trial all parameters.

### BACKGROUND OF THE INVENTION

1. Field of the Invention

The present invention relates to an image processing apparatus for applying image processing to image data in accordance with a designated parameter, and an image processing program storage medium storing an image processing program, when executed in a computer, which causes the computer to operate as the image processing apparatus.

2. Description of the Related Art

Hitherto, it is widely performed that a personal computer and the like are used to apply a predetermined processing to photographic image data, which is obtained through photography of the subject by a digital camera, and image data, which is obtained through reading of an original image by a scanner, so that an image nice to look at can be obtained. When a correction work for such an image is carried out, usually, there is used an all-purpose retouching software. When an operator designates various types of parameters related to image processing through a mouse and a keyboard in accordance with a setting screen provided by the retouching software, the image processing according to the parameters is applied to the image data. As the parameters referred to here, there are raised for example, density of highlight and shadow, and correction factors for color correction and color tone conversion.

By the way, in order to set up those parameters to suitable values at once, there is needed very skilled technique. Accordingly, usually, in order to obtain suitable parameters for creating a desired image, there are repeated over and over again such a series of works that parameters are designated through trial and error, an image, which is subjected to image processing in accordance with the designated parameters, is displayed on display unit and the like, and the displayed image is confirmed, so that the parameters are designated over again.

In this manner, in the event that the designation of the parameters is repeated over again, it is preferable that parameters in halfway up to the final determination of the complete parameters are temporarily stored, and the parameters in halfway are allowed to be restored in the process of trial and error. With respect to this technology, the conventional retouching software is provided with an undo function in which the last action is reversed, for example, a parameter, which is set up immediately before the parameter is renewed (according to the present specification, a designation of a parameter created based on a certain parameter is referred to as “be renewed”), is undone, and a history function in which a history of the used parameters is displayed. Japanese Patent Application Laid Open Gazette TokuKai 2001-243487 and Japanese Patent Application Laid Open Gazette TokuKai Hei. 5-120401 disclose technologies related to those functions.

However, the above-mentioned undo function and history function, and the technologies disclosed in Japanese Patent Application Laid Open Gazette TokuKai 2001-243487 and Japanese Patent Application Laid Open Gazette TokuKai Hei. 5-120401 are associated with the problems set forth below.

For example, according to the above-mentioned various functions, it is possible to sequentially designate parameter 1, parameter 2, parameter 3, and parameter 4, and then subsequently to call the parameter 2. However, in the event that after the parameter 2 is called, a parameter 2_{—}1, which is created based on the parameter 2, is designated, there would occur such an inconvenience that the parameter 3 and the parameter 4, which are designated during a period of time from a designation of the parameter 2 to a designation of the parameter 2_{—}1, cannot be restored. Particularly, as mentioned above, in the event that parameters are set up through trial and error, it is preferable that all the parameters on trial can be readily restored.

### SUMMARY OF THE INVENTION

In view of the foregoing, it is an object of the present invention to provide an image processing apparatus capable of readily restoring the parameters set up, and an image processing program storage medium storing an image processing program, when executed in a computer, which causes the computer to operate as the image processing apparatus.

To achieve the above-mentioned object, the present invention provides an image processing apparatus comprising:
an image processing section that receives a designation of a parameter group consisting of at least one parameter related to image processing and applies image processing according to the parameter group to image data representative of an image;
a parameter designation section that designates the parameter group for the image processing section, the parameter designation section being also capable of performing a renewal designation in accordance with the parameter group already designated; and
a parameter saving section wherein when the renewal designation of the parameter group is performed through the parameter designation section, the parameter group before the renewal designation is associated with the parameter group after the renewal designation so that both the parameter groups are saved,
wherein the parameter designation section selects one parameter group from among the parameter groups saved in the parameter saving section, as a parameter group which is an original of renewal designation, and
the parameter saving section saves parameter groups in such a manner that when the parameter designation section performs a plurality of number of times of renewal designation in accordance with an identical parameter group, a plurality of parameter groups, which is designated in accordance with the plurality of number of times of renewal designation to the identical parameter group, is associated with one another on a parallel basis.

According to the image processing apparatus of the present invention as mentioned above, it is possible to perform “renewal designation” for designating a parameter group in accordance with a parameter group already designated, as well as usual “designation” in which an operator designates a desired parameter group. The parameter group, which is subjected to the renewal designation, is associated with the parameter group that is an original parameter group for the renewal designation. In the event a plural number of times of renewal designation is made in accordance with the same parameter group, a plurality of parameter groups is associated with one another on a parallel basis and is saved. Thus, the parameter groups, which are subjected to designation and renewal designation, are not erased and saved on a hierarchical basis. Accordingly, it is possible to restore trial all parameters.

In the image processing apparatus according to the present invention as mentioned above, it is preferable that the image processing apparatus further comprises an image display section in which when the image processing section applies the image processing, an image representative of the image data to which the image processing is applied, is displayed.

This feature makes it possible for an operator to perform designation of parameter groups while confirming on the image display section an image subjected to image processing in accordance with the designated parameter group. Accordingly, even an operator, who has no skilled technique, can guess how to correct parameter groups to obtain a desired image, and thus it is possible to effectively perform a designation of parameter groups.

In the image processing apparatus according to the present invention as mentioned above, it is preferable that the image processing apparatus further comprises a relation display section that displays in form of figure a relation in which parameter groups saved in the parameter saving section are associated with one another,
wherein the parameter saving section selects parameter group, which is an original of the renewal designation, on a figure to be displayed on the relation display section.

This feature makes it possible to display a relation wherein parameter groups are associated with one another, in form of a figure easy to visually recognize, and in addition possible for an operator to select on the figure the parameter group, which is the original parameter group for the renewal designation. Thus, according to the image processing apparatus of the present invention, it is possible to provide GUI (Graphical User Interface) which is easy to use.

In the image processing apparatus according to the present invention as mentioned above, it is acceptable that the relation display section displays a relation in which parameter groups, which are originals for the renewal designation, are restricted to a predetermined number of pieces, of relations in which the parameter groups are associated with one another.

Further to achieve the above-mentioned object, the present invention provides an image processing program storage medium storing an image processing program which causes a computer to operate as an image processing apparatus, when the image processing program is executed in the computer, wherein the image processing program storage medium stores the image processing program comprising:
an image processing section that receives a designation of a parameter group consisting of at least one parameter related to image processing and applies image processing according to the parameter group to image data representative of an image;
a parameter designation section that designates the parameter group for the image processing section, the parameter designation section being also capable of performing a renewal designation in accordance with the parameter group already designated; and
a parameter saving section wherein when the renewal designation of the parameter group is performed through the parameter designation section, the parameter group before the renewal designation is associated with the parameter group after the renewal designation so that both the parameter groups are saved,
wherein the parameter designation section selects one parameter group from among the parameter groups saved in the parameter saving section, as a parameter group which is an original of renewal designation, and
the parameter saving section saves parameter groups in such a manner that when the parameter designation section performs a plurality of number of times of renewal designation in accordance with an identical parameter group, a plurality of parameter groups, which is designated in accordance with the plurality of number of times of renewal designation to the identical parameter group, is associated with one another on a parallel basis.

When the image processing program is executed in the computer, the computer operates as the image processing apparatus as mentioned above.

With respect to the image processing program storage medium of the present invention, only the basic aspects are disclosed here. It is noted that the image processing program storage medium of the present invention include not only the basic aspects, but also various aspects corresponding to the above-mentioned aspects of the image processing apparatus.

While the similar names are applied to the structural elements in the image processing apparatus and the image processing program storage medium, those structural elements mean the hardware and the software in the image processing apparatus, and mean only the software in the image processing program storage medium.

### BRIEF DESCRIPTION OF THE DRAWINGS

FIG. 1 is a schematic constitution view of an image processing system to which an embodiment of the present invention is applied.

FIG. 2 is a perspective view of a personal computer.

FIG. 3 is a hardware structural view of the personal computer.

FIG. 4 is a conceptual view showing a CD-ROM storing an image processing program, as an embodiment of an image processing program storage medium according to the present invention.

FIG. 5 is a functional block diagram of an embodiment of an image processing apparatus according to the present invention.

FIG. 6 is a view showing an example of a set-up image plane displayed on a display screen.

FIG. 7 is a flowchart useful for understanding an example of an order in which parameter groups are designated plural numbers of time.

FIG. 8 is an explanatory view useful for understanding a method of saving parameter groups in a parameter saving section wherein parameter groups are designated in accordance with the order shown in FIG. 7.

FIG. 9 is a view showing displays in a history section on the set-up image plane shown in FIG. 6 wherein parameter groups are designated in accordance with the order shown in FIG. 7.

### DETAILED DESCRIPTION OF PREFERRED EMBODIMENTS

Embodiments of the present invention will be described with reference to the accompanying drawings.

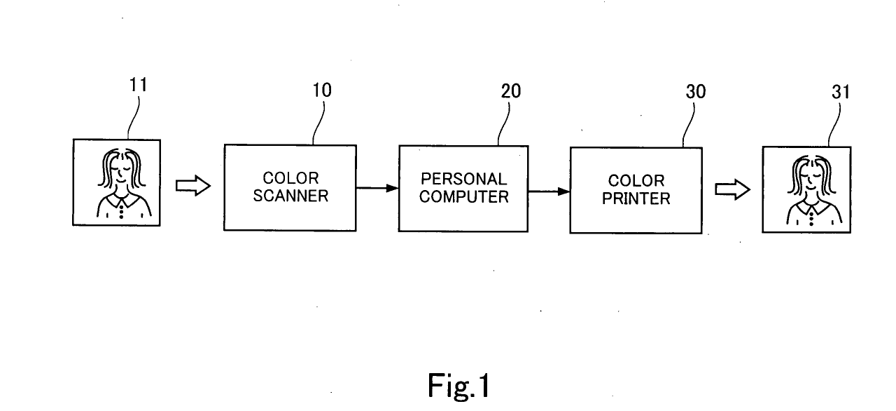

FIG. 1 is a schematic constitution view of an image processing system to which an embodiment of the present invention is applied.

A color scanner 10 reads an original image 11 and produces image data for four colors of C, M, Y and K. The image data of C, M, Y and K produced by the color scanner 10 is fed to a personal computer 20. The personal computer 20 applies an image processing to the image data produced by the color scanner 10 so that an image represented by the image data is corrected to be an image nice to look at. Further, the personal computer 20 converts the image data produced by the color scanner 10 into image data suitable for a color printer 30, which will be described later. The image data for printing is fed to the color printer 30. The color printer 30 performs a printing in accordance with the image data thus fed so that a print image 31 is formed.

According to the image processing system shown in FIG. 1, as an example of the image output apparatus for outputting an image in accordance with image data, there is shown the color printer 30. It is acceptable that the color printer 30 is an electrophotographic system of color printer or an ink jet system of color printer and any one of the printing systems is acceptable. Further, as the image output apparatus, it is not restricted to a printer, and it is acceptable that the image output apparatus is a printing machine. However, as an embodiment of the present invention, there will be explained an image processing system provided with the color printer 30 as an example of the image output apparatus.

An aspect as an embodiment of the present invention in the image processing system shown in FIG. 1 resides in processing contents to be executed inside the personal computer 20. Hereinafter, there will be described the personal computer 20.

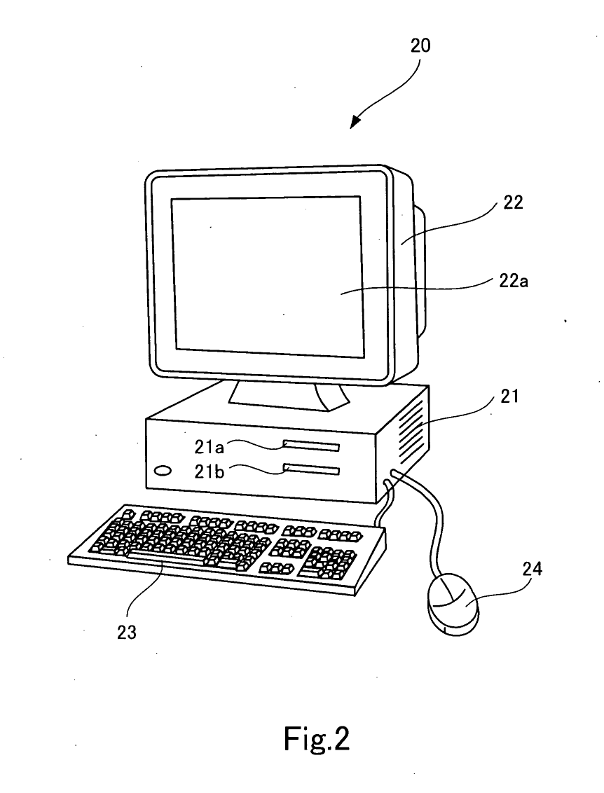

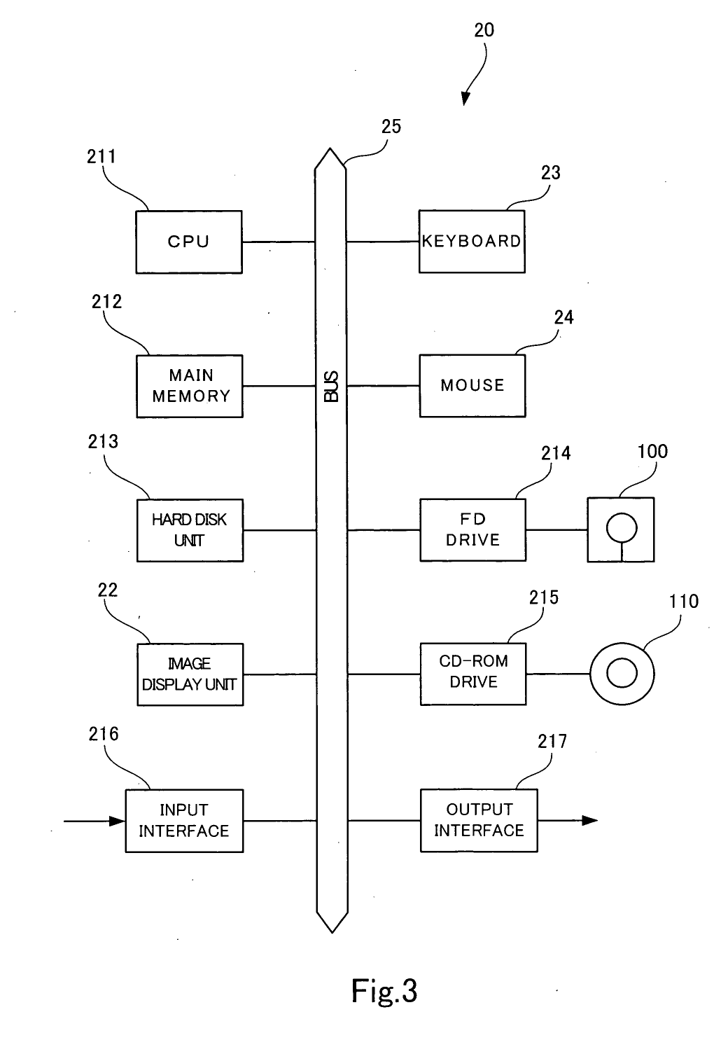

FIG. 2 is a perspective view of the personal computer 20 shown in FIG. 1. FIG. 3 is a hardware structural view of the personal computer 20.

The personal computer 20 comprises, on an external appearance, a main frame unit 21, an image display unit 22 for displaying an image on a display screen 22a in accordance with an instruction from the main frame unit 21, a keyboard 23 for inputting various sorts of information to the main frame unit 21 in accordance with a key operation, and a mouse 24 for inputting an instruction according to, for example, an icon and the like, through designation of an optional position on the display screen 22a, the icon and the like being displayed on the position on the display screen 22a. The main frame unit 21 has, on an external appearance, a flexible disk mounting slot 21a for mounting a flexible disk (FD), and a CD-ROM mounting slot 21b for mounting a CD-ROM.

The main frame unit 21 comprises, as shown in FIG. 3, a CPU 211 for executing a various types of program, a main memory 212 in which a program stored in a hard disk unit 213 is read out and developed for execution by the CPU 211, the hard disk unit 213 for saving various types of programs and data, an FD drive 214 for accessing an FD disk 100 mounted thereon, a CD-ROM drive 215 for accessing a CD-ROM 110 mounted thereon, an input interface 216 connected to the color scanner 10 (cf. FIG. 1), to receive image data from the color scanner 10, and an output interface 217 to transmit image data to the color printer 30. These various types of elements are connected via a bus 25 to the image display unit 22, the keyboard 23 and the mouse 24.

The CD-ROM 110 stores therein an image processing program for causing the personal computer 20 to operate as an image processing apparatus of the present invention. The CD-ROM 110 is mounted on the CD-ROM drive 215 so that the image processing program, which is stored in the CD-ROM 110, is up-loaded on the personal computer 20 and is stored in the hard disk unit-213. When the image, processing program is executed, the personal computer 20 serves as an image processing apparatus according to an embodiment of the present invention.

Next, there will be explained the image processing program to be executed in the personal computer 20.

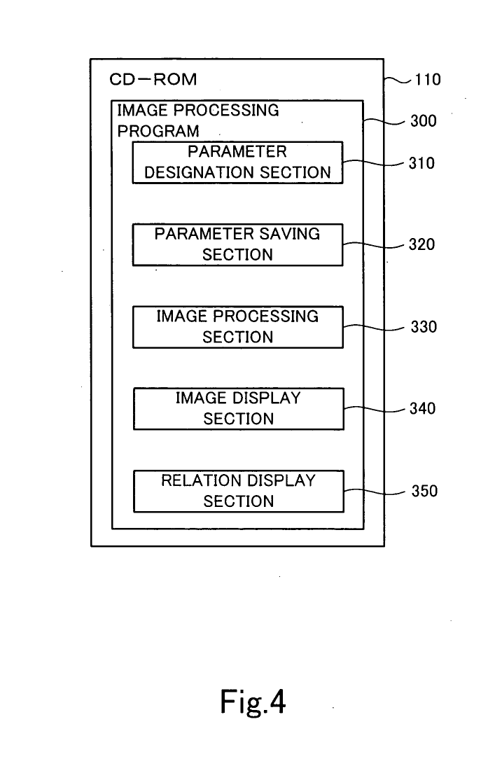

FIG. 4 is a conceptual view showing a CD-ROM storing an image processing program, as an embodiment of an image processing program storage medium according to the present invention.

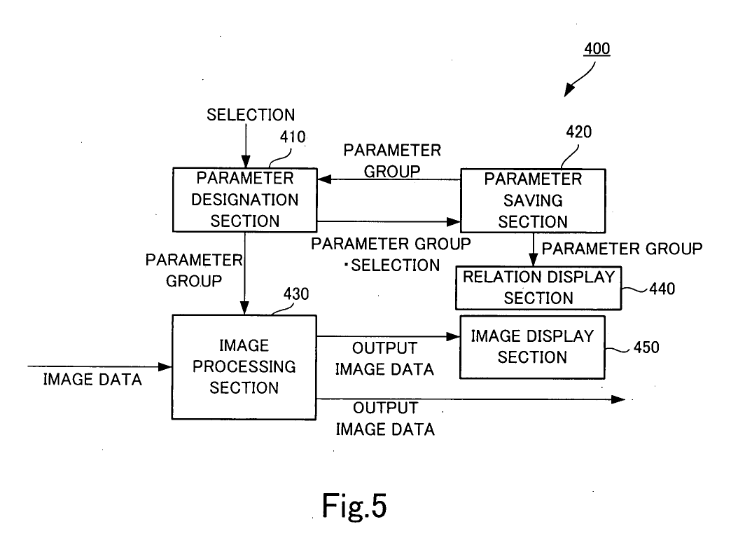

An image processing program 300 comprises a parameter designation section 310, a parameter saving section 320, an image processing section 330, an image display section 340, and a relation display section 350. The parameter designation section 310 corresponds to an example of the parameter designation section of the image processing program stored in the image processing program storage medium of the present invention. Likely, the parameter saving section 320, the image processing section 330, the image display section 340, and the relation display section 350 correspond to examples of the parameter saving section, the image processing section, the image display section, and the relation display section of the image processing program stored in the image processing program storage medium of the present invention, respectively. Details of the respective sections of the image processing program 300 will be described together with the functions of the respective sections of an image processing apparatus 400 shown in FIG. 5, which is an embodiment of an image processing apparatus of the present invention.

FIG. 5 is a functional block diagram of the image processing apparatus 400 where the image processing program 300 is installed in the personal computer 20 shown in FIG. 1 to FIG. 3 so that the personal computer 20 serves as an image processing apparatus according to an embodiment of the present invention.

The image processing apparatus 400 comprises a parameter designation section 410, a parameter saving section 420, an image processing section 430, a relation display section 440, and an image display section 450. When the image processing program 300 shown in FIG. 4 is installed in the personal computer 20 shown in FIG. 1 to FIG. 3, the parameter designation section 310 of the image processing program 300 constitutes the parameter designation section 410 of the image processing apparatus 400. Likely, the parameter saving section 320, the image processing section 330, the image display section 340, and the relation display section 350 constitute the parameter saving section 420, the image processing section 430, the image display section 450, and the relation display section 440, respectively.

The parameter saving section 420 shown in FIG. 5 receives from the parameter designation section 410 parameter groups related to the image processing to be performed in the image processing section 430 and saves the parameter groups. Here, the word “saving” means a systematic storage of parameter groups in the hard disk unit 213 shown in FIG. 1. That is, when parameter groups designated by an operator are entered through the parameter designation section 410, the parameter groups are stored in the hard disk unit 213. When the parameter saving section 420 receives from the parameter designation section 410 selection information in which one of the saved parameter groups is selected, the parameter saving section 420 derives from the hard disk unit 213 a parameter group represented by the selection information, and sends the same to the parameter designation section 410. Further, the parameter saving section 420 sends to the relation display section 440 parameter groups, of which the number of pieces is less than a predetermined number of pieces, including the parameter groups entered through the parameter designation section 410. With respect to a method of saving parameter groups in the parameter saving section 420, it will be described later in details. The parameter saving section 420 corresponds to an example of the parameter saving section in an image processing apparatus of the present invention.

With respect to the relation display section 440, the CPU 211 and the image display unit 22 shown in FIG. 3 serve as the relation display section 440. When the relation display section 440 receives parameter groups not less than a predetermined number of pieces from the parameter saving section 420, the relation display section 440 displays a figure representative of a mutual relation of the parameter groups on the display screen 22a shown in FIG. 2. The relation display section 440 corresponds to an example of the relation display section of an image processing apparatus of the present invention.

With respect to the parameter designation section 410, the keyboard 23 and the mouse 24 shown in FIG. 2 serve as the parameter designation section 410. The parameter designation section 410 designates a parameter group related to the image processing to be performed in the image processing section 430. According to the present embodiment, as designations of parameter groups to be performed in the parameter designation section 410, there are two sorts of a “selection designation” in which an operator selects a desired parameter, and a “renewal designation” in which a parameter group is renewed in accordance with the parameter group subjected to the “selection designation”. The “renewal designation” corresponds to an example of the “renewal designation” referred to in the present invention.

There will be described the outline of the procedure of the “selection designation” and the “renewal designation”, hereinafter.

On the display screen 22a shown in FIG. 2, the relation display section 440 displays a plurality of parameter groups, which is already designated. When an operator uses the mouse 24 and the like to select a desired parameter group from among the displayed parameters (“selection designation”), the parameter designation section 410 sends to the parameter saving section 420 selection information for discriminating the selected parameter group. When the parameter saving section 420 receives the selection information, the parameter saving section 420 sends to the parameter designation section 410 a parameter group represented by the selection information, and the selected parameter group is displayed on the display screen 22a. The operator corrects the parameter group in accordance with the parameter group displayed on the display screen 22a (“renewal designation”).

The parameter group designated by the “renewal designation” is transmitted to the image processing section 430 and the parameter saving section 420. The parameter designation section 410 corresponds to an example of the parameter designation section of an image processing apparatus of the present invention.

The image processing section 430 applies image processing to image data in accordance with the parameter group transmitted from the parameter designation section 410 and creates output image data. The output image data thus created is transmitted to the image display section 450, and in the event that instruction for the printing output is made, the output image data is outputted to the color printer 30 shown in FIG. 1. The image processing section 430 corresponds to the image processing section of an image processing apparatus of the present invention.

With respect to the image display section 450, the CPU 211 and the image display unit 22 shown in FIG. 3 serve as the image display section 450. When the image display section 450 receives output image data from the image processing section 430, the image display section 450 displays an image based on the output image data on the display screen 22a shown in FIG. 2. The image display section 450 corresponds to an example of the image display section of an image processing apparatus of the present invention.

The image processing apparatus 400 is basically constructed as mentioned above.

Next, there will be explained a set-up image plane for designating the parameter groups, which are provided from the image processing apparatus 400.

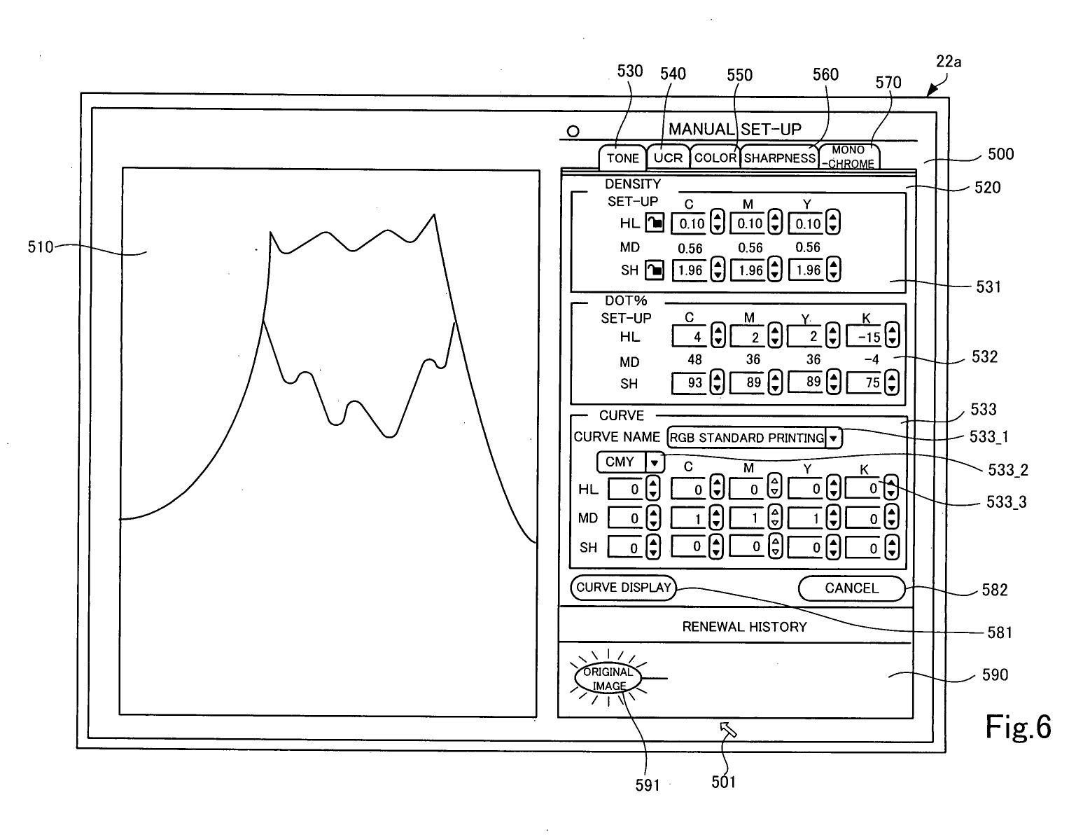

FIG. 6 is a view showing an example of a set-up image plane displayed on the display screen 22a. According to this example, a designation of parameter groups by an operator is not made, and as the parameter group, the initial value prepared beforehand is set up. And there is displayed an image based on image data to which image processing is applied in accordance with the parameter group in the initial state.

A set-up image plane 500 comprises an image section 510 for displaying an image based on image data, a set-up section 520 for setting up various parameters related to the image processing, and a history section 590 indicative of a history of a parameter group set up in the set-up section 520.

The set-up section 520 comprises a tone page 530 for setting up a parameter related to a tone, a UCR page 540 for setting up a parameter related to UCR (Under Color Remove), a color page 550 for setting up a parameter related to color correction, a sharpness page 560 for setting up a parameter related to a sharpness, and a monochrome page 570 for setting up a parameter wherein a color image is converted into a monochromatic image. The tone page 530 comprises a density set-up section 531 for setting up densities in highlight and shadow, a dot % set-up section 532 for setting up dot % values in highlight and shadow, and a curve set-up section 533 for setting up a curve connecting the highlight, the middle and the shadow with one another. The curve set-up section 533 comprises a curve selection box 533_1 for selecting a sort of curves, a color selection box 533_2 for setting up a degree of correction selecting as the criterion a curve selected in the curve selection box 533_1, and a correction box 533_3. The color selection box 533_2 is for selecting a color for the offset. Of the correction box 533_3, a first box below the color selection box 533_2 is for designating the offset to be applied on a common basis for all colors to the highlight, the middle and the shadow. Of the correction box 533_3, a second box below the curve selection box 533_1 is for making fine adjustments to the offset designated in the first box for each color.

The set-up section 520 further comprises a curve display button 581 for displaying on the image section 510 curves created in accordance with the various parameters set up in the curve set-up section 533, and a cancel button 582 for resetting the various parameters set up in the set-up section 520 to the parameters in the initial state.

The history section 590 is displayed by the relation display section 440 shown in FIG. 5. On the history section 590, there is displayed an icon representative of an aspect of the parameter group transmitted from the parameter saving section 420 to the relation display section 440 shown in FIG. 5. In the event that a plurality of icons exists, those icons are coupled with one another through lines so that the icons are expressed on a diagrammatic basis. According to this example, it is assumed that up to three icons can be displayed on a line basis in a horizontal direction. And the icon representative of the parameter group designated at that time point turns on and off. According to this example, no designation of a parameter group by an operator is made, an icon 591 representative of the initial state turns on and off. When an operator brings the pointer 501 with a desired icon displayed on the history section 590, it is possible to select a parameter group associated with the icon.

On the image section 510, the image display section 450 shown in FIG. 5 displays an image represented by the output image data in which image processing according to the parameter group set up in the set-up section 520 is applied to image data.

An aspect of an image processing apparatus of the present invention resides in saving method and display method of parameter groups wherein designation of the parameter groups is repeated.

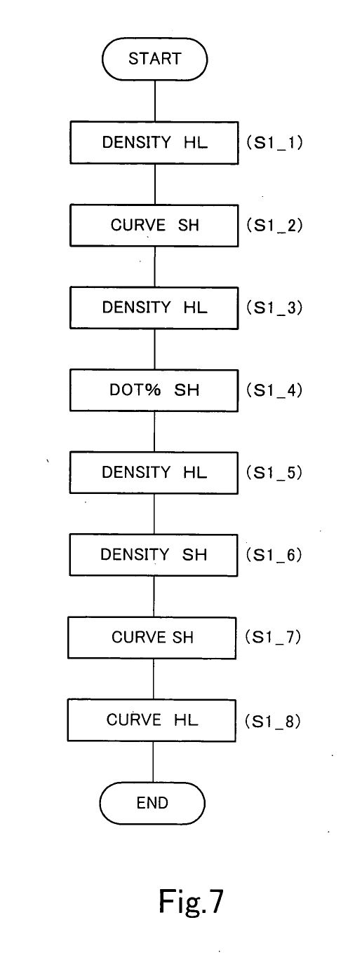

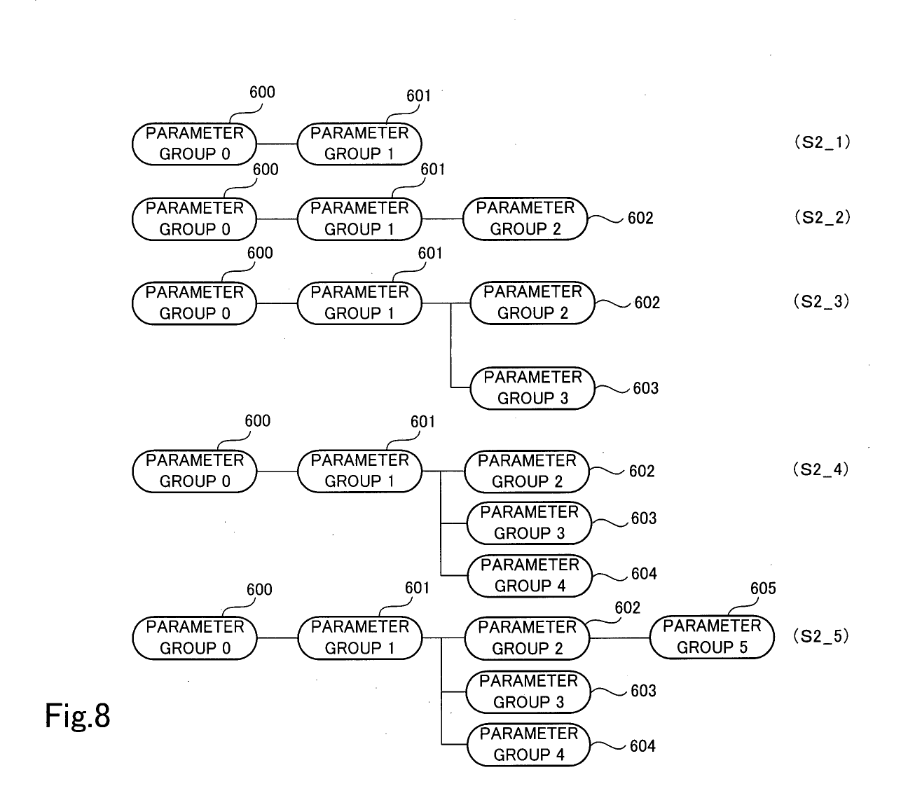

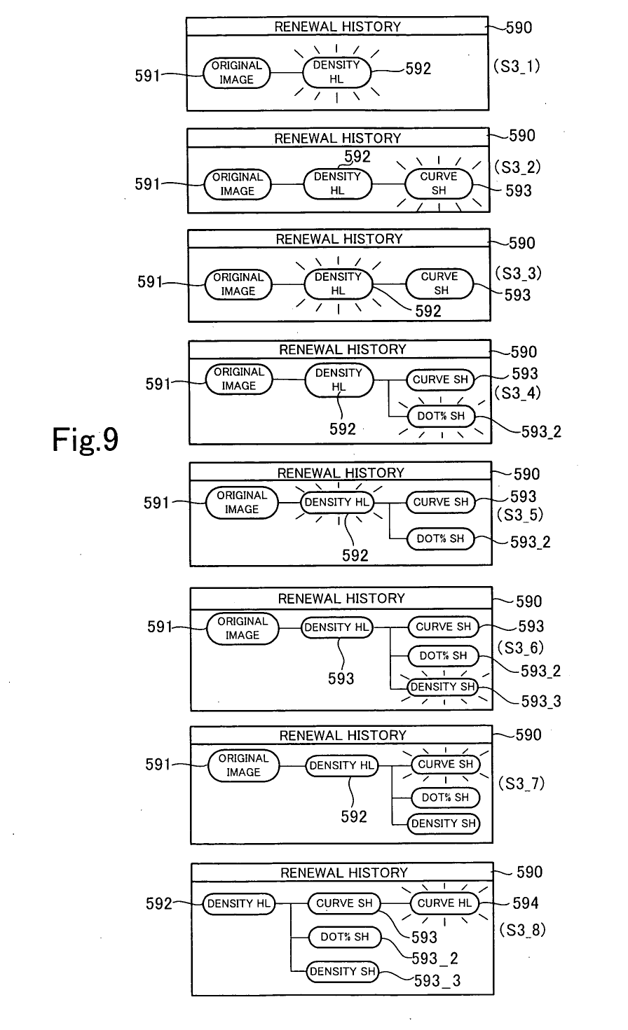

FIG. 7 is a flowchart useful for understanding an example of an order in which parameter groups are designated plural numbers of time. FIG. 8 is an explanatory view useful for understanding a method of saving parameter groups in a parameter saving section wherein parameter groups are designated in accordance with the order shown in FIG. 7. FIG. 9 is a view showing displays in a history section on the set-up image plane shown in FIG. 6 wherein parameter groups are designated in accordance with the order shown in FIG. 7. Hereinafter, there will be explained details of saving method and display method of parameter groups wherein designation of the parameter groups is repeated, referring to FIG. 5 and FIG. 6 as well as FIG. 7, FIG. 8 and FIG. 9.

First, when an operator confirms the set-up image plane 500 in the initial state as shown in FIG. 6, and uses the mouse 24 and the like to alter the value of “density HL (highlight)” of the density set-up section 531 (step S1_1 in FIG. 7), the parameter designation section 410 shown in FIG. 5 designates a new parameter group, in which only the value of the “density HL” is different from the parameter group in the initial state. This new parameter group is transmitted from the parameter designation section 410 to the parameter saving section 420 and the image processing section 430.

At that time, the image processing section 430 applies the image processing to image data in accordance with the transmitted new parameter group so as to create output image data. The output image data thus created is transmitted to the image display section 450, so that an image according to the output image data is displayed on the image section 510 shown in FIG. 6.

The parameter saving section 420 saves, as shown in step S2_1 of FIG. 8, the transmitted new parameter group in form of a first parameter group 601, which is designated in accordance with the initial parameter group 600, in the initial state. The parameter saving section 420 transmits the initial parameter group 600 and the first parameter group 601 to the relation display section 440 shown in FIG. 5.

The relation display section 440 displays, as shown in step S3_1 of FIG. 9, a figure in which an icon 591 indicated as “original image”, which represents the initial parameter group 600 of FIG. 8, is coupled in series with an icon 592 indicated as “density HL”, which represents the first parameter group 601.

A series of processing mentioned above, which is carried out when the step S1_1 in FIG. 7 is designated, corresponds to the processing of the above-mentioned “renewal designation”.

Also in the step S1_2 et seqq., the image processing section 430 shown in FIG. 5 performs image processing whenever a parameter group is designated, and the image display section 450 displays an image according to the output image data on the image section 510 shown in FIG. 6. However, those processing are the same every time, and thus explanation will be omitted.

Subsequent to the step S11 in FIG. 7, when an operator enters a value of “curve SH (shadow)” of the curve set-up section 533 (step S1_2) of FIG. 6, the parameter designation section 410 designates a new parameter group wherein only the value of “curve SH” is altered, in accordance with the first parameter group 601 shown in FIG. 8. A series of processing, which is carried out when the step S1_2 is designated, also corresponds to the above-mentioned “renewal designation”.

The parameter saving section 420 saves, as shown in step S2_2 of FIG. 8, the newly designated parameter group in form of a second parameter group 602 which is designated in accordance with the first parameter group 601. The parameter saving section 420 sends to the relation display section 440 the initial parameter group 600, the first parameter group 601 and the second parameter group 602.

As shown in step S3_2 of FIG. 9, on the history section 590 displayed by the relation display section 440, there is displayed a figure in which an icon 591 indicated as “original image”, which is representative of the initial parameter group 600 of FIG. 8, an icon 592 indicated as “density HL”, which is representative of the first parameter group 601, and an icon 593 indicated as “curve SH”, which is representative of the second parameter group 602 are coupled with one another in series. Here, the icon 593 representative of the second parameter group 602, which is now designated, turns on and off.

Next, an operator uses the mouse 24 and the like to select the icon 592 indicated as “density HL” from among three icons shown in the step S3_2 of FIG. 9 (step S1_3 of FIG. 7), the parameter designation section 410 shown in FIG. 5 sends to the parameter saving section 420 selection information indicating that the first parameter group 601 (cf. FIG. 8) associated with the icon 592 is selected. A series of processing, which is carried out when the step S1_3 is selected, corresponds to the processing of the above-mentioned “selection designation”.

Upon receipt of the selection information, the parameter saving section 420 derives the first parameter group 601 saved as shown in step S2_2 of FIG. 8, and transmits the first parameter group 601 to the parameter designation section 410. Further, the parameter saving section 420 transmits to the relation display section 440 the initial parameter group 600, the first parameter group 601 and the second parameter group 602. When the parameter designation section 410 receives the first parameter group 601, values of the various parameters displayed on the set-up section 520 shown in FIG. 6 are rewritten into values of the first parameter group 601.

As shown in step S3_3 of FIG. 9, on the history section 590 displayed by the relation display section 440, there is displayed a figure which is the same as the figure shown in the step S3_2. Here, the icon 592 representative of the first parameter group 601 of FIG. 8, which is now designated, turns on and off.

Next, when an operator rewrites only the value of “dot % SH” of the dot % set-up section 532 in accordance with the parameter group indicated in the set-up section 520 of FIG. 6 (step S1_4 of FIG. 7), the parameter designation section 410 of FIG. 5 designates a new parameter group wherein only “dot % SH” is altered, in accordance with the first parameter group 601 shown in FIG. 8.

In the parameter saving section 420, as shown in step S2_3 of FIG. 8, the newly designated third parameter group 603 is associated with the first parameter group 601, and the second parameter group 602 and the third parameter group 603, which are designated in accordance with the first parameter group 601, are arranged in parallel. And the first parameter group 601, the second parameter group 602 and the third parameter group 603 are saved on a hierarchical basis. The parameter saving section 420 transmits to the relation display section 440 the initial parameter group 600, the first parameter group 601, the second parameter group 602 and the third parameter group 603, which are derived from the first parameter group 601.

As shown in step S3_4 of FIG. 9, on the history section 590 displayed by the relation display section 440, there is displayed a figure in which the icon 593 indicated as “curve SH”, which is representative of the second parameter group 602 of FIG. 8, and an icon 593_2 indicated as “dot % SH”, which is representative of the third parameter group 603, are derived from the icon 592 indicated as “density HL”, which is representative of the first parameter group 601.

Here, according to the “undo function” and the “history function” provided on the conventional retouching software and the like, as shown in step S2_3 of FIG. 8, when the third parameter group 603 is designated on a renewal basis in accordance with the first parameter group 601, the second parameter group 602, which was designated on a renewal basis in accordance with the first parameter group 601, prior to the third parameter group 603, will be erased, and thus it is impossible to restore the second parameter group 602. On the other hand, according to the image processing apparatus 400 of the present invention, a selection of a desired one of the icons shown in step S3_4 of FIG. 9 makes it possible to readily restore the parameter group represented by the icon.

Next, in a similar fashion to that of the step S1_3 of FIG. 7, when an operator selects the icon 592 shown in FIG. 9 by the mouse 24 and the like (step S1_5 of FIG. 7), the parameter designation section 410 shown in FIG. 5 sends to the parameter saving section 420 selection information indicating that the first parameter group 601 (cf. FIG. 8) associated with the icon 592 is selected. When the parameter designation section 410 receives the first parameter group 601, values of the various parameters displayed on the set-up section 520 shown in FIG. 6 are rewritten into values of the first parameter group 601.

At that time, on the history section 590 displayed by the relation display section 440, there is displayed a figure which is the same as the figure shown in the step S₃_4. In step S3_5, the icon 592 representative of the first parameter group 601 of FIG. 8, which is now designated, turns on and off.

Next, when an operator rewrites only the value of “density SH” of the density set-up section 531 in accordance with the parameter group indicated in the set-up section 520 of FIG. 6 (step S1_6 of FIG. 7), the parameter designation section 410 of FIG. 5 designates a new parameter group wherein only “density SH” is altered, in accordance with the first parameter group 601 shown in FIG. 8.

In the parameter saving section 420, as shown in step S2_4 of FIG. 8, the newly designated fourth parameter group 604 is associated with the first parameter group 601, and the second parameter group 602, the third parameter group 603, and the fourth parameter group 604, which are designated in accordance with the first parameter group 601, are arranged in parallel. And the first parameter group 601, the second parameter group 602, the third parameter group 603, and the fourth parameter group 604 are saved on a hierarchical basis.

As shown in step S3_6 of FIG. 9, on the history section 590 displayed by the relation display section 440, there is displayed a figure in which the icon 593 indicated as “curve SH”, which is representative of the second parameter group 602 of FIG. 8, an icon 593_2 indicated as “dot % SH”, which is representative of the third parameter group 603, and an icon 593_3 indicated as “density SH”, which is representative of the fourth parameter group 604, are derived from the icon 592 indicated as “density HL”, which is representative of the first parameter group 601.

When a plurality of number of times of renewal designation is made in accordance with a certain parameter group, as shown in step S3_6 of FIG. 9, a display of icons each representative of the associated parameter group after renewal makes it possible for an operator to readily a relation between history in which parameter groups are renewed, and the parameter groups. Further, a selection of the icons by the mouse and the like to designate the parameter group represented by the selected icon makes it possible for an operator to readily select a desired parameter group through comparison with an image processing result according to the parameter groups.

Subsequent to the step S1_6 in FIG. 7, when an operator selects the icon 593 indicated as “curve SH” from among five icons shown step S3_6 of FIG. 9 by the mouse 24 and the like (step S1_7 of FIG. 7), the parameter designation section 410 shown in FIG. 5 sends to the parameter saving section 420 selection information indicating that the second parameter group 602 (cf. FIG. 8) associated with the icon 593 is selected. When the parameter designation section 410 receives the second parameter group 602, values of the various parameters displayed on the set-up section 520 shown in FIG. 6 are rewritten into values of the second parameter group 602.

On the history section 590 displayed by the relation display section 440, there is displayed a figure which is the same as the figure shown in the step S3_6. In step S3_7, the icon 593 representative of the second parameter group 602 of FIG. 8, which is now designated, turns on and off.

Next, when an operator rewrites the value of “curve SH” of the curve set-up section 533 in accordance with the parameter group indicated in the set-up section 520 of FIG. 6 (step S1_8 of FIG. 7), the parameter designation section 410 of FIG. 5 designates a new parameter group which is different in only “curve SH” from the second parameter group 602 of FIG. 8.

In the parameter saving section 420, as shown in step S2_5 of FIG. 8, the newly designated fifth parameter group 605 is associated with the second parameter group 602 and is saved. Here, on the history section 590 shown in FIG. 6 and FIG. 9, up to three icons representative of parameter groups are simply displayed in the horizontal direction. Thus, the parameter saving section 420 sends to the relation display section 440 three parameter groups in lateral direction (the first parameter group 601, the second parameter group 602, and the fifth parameter group 605 that is the latest parameter group), and parameter groups which are arranged in parallel to those three parameter groups, that is, the third parameter group 603 and the fourth parameter group 604 which are arranged in parallel to the second parameter group 604.

As shown in step S3_8 of FIG. 9, on the history section 590 displayed by the relation display section 440, there is displayed no icon 591 representative of the initial state, but a figure in which the icon 592 representative of the first parameter group 601 of FIG. 8, the icon 593 representative of the second parameter group 602 of FIG. 8, and icon indicated as “curve HL”, which is representative of the fifth parameter group, are coupled with one another in lateral direction, and the icon 593_2 representative of the third parameter group 603, and the icon 593_3 representative of the fourth parameter group 604, are arranged in parallel to the icon 593 representative of the second parameter group 602.

In this manner, when a parameter group, which is an original of renewal designation, is associated with a parameter group after the renewal, and the relation therebetween is displayed in form of figure, the relation between the parameter groups is easily understood, and thus it is possible for an operator to readily designate parameter groups.

Incidentally, according to the explanation as mentioned above, as an example of the parameter designation section of an image processing apparatus of the present invention, there is disclosed an example of the parameter designation section having functions of “selection designation” for selecting a desired parameter group, and “renewal designation” for performing a renewal in accordance with the designated parameter group. It is acceptable, however, that the parameter designation section of an image processing apparatus of the present invention has further function of “new designation” for newly designating a desired parameter group.

According to the above description, there is disclosed an image processing apparatus capable of designating parameter groups related to tone and UCD. However, any one is acceptable, as the parameter groups capable of being designated in the parameter designation section of an image processing apparatus of the present invention, which are related to the image processing.

According to the explanation as mentioned above, as an example of the parameter saving section of an image processing apparatus of the present invention, there is disclosed an example of the parameter saving section for storing parameter groups into a hard disk unit provided on the exterior of the parameter saving section. It is acceptable, however, that the parameter saving section of an image processing apparatus of the present invention has an inside storage area for storing the parameter groups.

According to the explanation as mentioned above, as an example of the relation display section of an image processing apparatus of the present invention, there is disclosed an example of a relation display section in which up to three relations of parameter groups are displayed in the lateral direction. It is acceptable, however, that the relation display section of an image processing apparatus of the present invention displays parameter groups of which the number is designated by an operator.

According to the explanation as mentioned above, as an example of the relation display section of an image processing apparatus of the present invention, there is disclosed an example of a relation display section for displaying a figure in which a parameter group after the renewal designation is hanged down from the parameter group, which is an original of renewal designation. However, any one is acceptable, as the relation display section referred to in the present invention, which display a figure in which a parameter group, which is an original of renewal designation, is associated with a parameter group after the renewal designation.

As mentioned above, according to the present invention, it is possible to readily restore the set up parameters.

While the present invention has been described with reference to the particular illustrative embodiments, it is not to be restricted by those embodiments but only by the appended claims. It is to be appreciated that those skilled in the art can change or modify the embodiments without departing from the scope and sprit of the present invention.

1. An image processing apparatus comprising:
an image processing section that receives a designation of a parameter group consisting of at least one parameter related to image processing and applies image processing according to the parameter group to image data representative of an image;
a parameter designation section that designates the parameter group for the image processing section, the parameter designation section being also capable of performing a renewal designation in accordance with the parameter group already designated; and
a parameter saving section wherein when the renewal designation of the parameter group is performed through the parameter designation section, the parameter group before the renewal designation is associated with the parameter group after the renewal designation so that both the parameter groups are saved,
wherein the parameter designation section selects one parameter group from among the parameter groups saved in the parameter saving section, as a parameter group which is an original of renewal designation, and
the parameter saving section saves parameter groups in such a manner that when the parameter designation section performs a plurality of number of times of renewal designation in accordance with an identical parameter group, a plurality of parameter groups, which is designated in accordance with the plurality of number of times of renewal designation to the identical parameter group, is associated with one another on a parallel basis.

2. An image processing apparatus according to claim 1, wherein the image processing apparatus further comprises an image display section in which when the image processing section applies the image processing, an image representative of the image data to which the image processing is applied, is displayed.

3. An image processing apparatus according to claim 1, further comprising a relation display section that displays in form of figure a relation in which parameter groups saved in the parameter saving section are associated with one another,
wherein the parameter saving section selects parameter group, which is an original of the renewal designation, on a figure to be displayed on the relation display section.

4. An image processing apparatus according to claim 3, wherein the relation display section displays a relation in which parameter groups, which are originals for the renewal designation, are restricted to a predetermined number of pieces, of relations in which the parameter groups are associated with one another.

5. An image processing program storage medium storing an image processing program which causes a computer to operate as an image processing apparatus, when the image processing program is executed in the computer, wherein the image processing program storage medium stores the image processing program comprising:
an image processing section that receives a designation of a parameter group consisting of at least one parameter related to image processing and applies image processing according to the parameter group to image data representative of an image;
a parameter designation section that designates the parameter group for the image processing section, the parameter designation section being also capable of performing a renewal designation in accordance with the parameter group already designated; and
a parameter saving section wherein when the renewal designation of the parameter group is performed through the parameter designation section, the parameter group before the renewal designation is associated with the parameter group after the renewal designation so that both the parameter groups are saved,
wherein the parameter designation section selects one parameter group from among the parameter groups saved in the parameter saving section, as a parameter group which is an original of renewal designation, and
the parameter saving section saves parameter groups in such a manner that when the parameter designation section performs a plurality of number of times of renewal designation in accordance with an identical parameter group, a plurality of parameter groups, which is designated in accordance with the plurality of number of times of renewal designation to the identical parameter group, is associated with one another on a parallel basis.
